(19) United States
(12) Patent Application Publication
(10) Pub. No.: US 2003/0005115 A1
(43) Pub. Date: Jan. 2, 2003

(54) System and method for providing access to a resource

(76) Inventors: Philip M. Walker, Fort Collins, CO (US); Kevin L. Colburn, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/893,112

(22) Filed: Jun. 27, 2001

(51) Int. Cl. G06F 15/173

(52) U.S. Cl. 709/225; 709/223

(57) ABSTRACT

The present disclosure relates to a system and method for providing access to a resource. The system and method both involve providing a graphical user interface (GUI) to an operator with which client connectivity with the resource is enabled, the GUI being configured such that the process used by the operator to facilitate connectivity using the GUI is the same regardless of which underlying connectivity method is used, receiving commands of the operator with the GUI that convey the identity of the client and the resource to be accessed by the client determining the client network configuration, and establishing client connectivity to the resource.

### FIELD OF THE INVENTION

The present disclosure relates to a system and method for providing access to a resource. More particularly, the disclosure relates to a system and method for simplifying the process with which an administrator facilitates this access.

### BACKGROUND OF THE INVENTION

Oftentimes, service providers offer access to certain resources to remote clients in exchange for a fee. For instance, some service providers permit clients to access high speed computers maintained by the service provider for predetermined lengths of time to conduct computations that more conventional computers lack the capacity and/or speed to complete efficiently. Typically, access is provided to the clients through various network connections. Therefore, for example, a client may send data (typically in packet form) to the service provider via the networks, and then receive the modified data resulting from the computations again via the networks.

In order for data to travel between two or more networks, there must be an effective path between the networks. Typically, this path is selected from multiple possible paths over a complex array of network devices (e.g., switches, routers, links, bridges, etc.). The nature of an effective path is normally dependent upon the various configurations of the network devices used in the two networks. These devices are arranged such that multiple possible paths exist so as to provide redundant communication paths, thereby increasing the likelihood that uninterrupted communications can be achieved. In the service provision scenario, however, critical gateways are normally used to create a single point of control over access to restricted resources so that greater security can be maintained by the service provider. In such a scenario, access to the resources basically equates to connectivity to the service provider network or networks that comprise these resources. In other words, to gain access is to become connected.

Typically, the service provider uses several operators or administrators that provide connectivity, and therefore grant access, to the service provider resources. In that the various clients that access the resources may use different network configurations, the administrator must be able to facilitate connectivity for different types of networks. Although connectivity can be provided for substantially any network configuration, the process of establishing this connectivity can be different for each. Therefore, the administrator must be trained to recognize the various network configurations of the clients and must be able to facilitate their connectivity. Unfortunately, it can be difficult for service providers to find, as well as retain, administrators with these skills. Even when such persons can be located and retained, their training and/or their salaries can be quite expensive.

Although graphical user interfaces (GUIs) have been developed for simplifying the administrator's control over connectivity so that less skilled administrators can be utilized, existing GUIs distinguish between the different connectivity methods for the various network configurations. Therefore, the administrators still must know how to manipulate the GUI for each connectivity situation. In addition, in that the method used is normally different for each different network configuration, there are many opportunities for mistakes to be made by the administrator.

From the foregoing, it can be appreciated that it would be desirable to have a simplified system and method for controlling access to a resource.

### SUMMARY OF THE INVENTION

The present disclosure relates to a method for providing access to a resource. The method comprises the steps of providing a graphical user interface (GUI) to an operator with which client connectivity with the resource is enabled, the GUI being configured such that the process used by the operator to facilitate connectivity using the GUI is the same regardless of which underlying connectivity method is used, receiving commands of the operator with the GUI that convey the identity of the client and the resource to be accessed by the client, determining the client network configuration, and establishing client connectivity to the resource.

In addition, the disclosure relates to a system for providing access to a resource. The system comprises means for providing a graphical user interface (GUI) to an operator with which client connectivity with the resource is enabled, the GUI being configured such that the process used by the operator to facilitate connectivity using the GUI is the same regardless of which underlying connectivity system is used, means for receiving commands of the operator with the GUI that convey the identity of the client and the resource to be accessed by the client, means for determining the client network configuration; and means for establishing client connectivity to the resource.

Furthermore, the disclosure relates to a computer readable medium for providing access to a resource. The computer readable medium comprises logic configured to provide a graphical user interface (GUI) to an operator with which client connectivity to the resource is enabled, the GUI being configured such that the process used by the operator to facilitate connectivity using means the GUI is the same regardless of which underlying connectivity computer readable medium is used, logic configured to receive commands of the operator with the GUI that convey the identity of the client and the resource to be accessed by the client, logic configured to determine the client network configuration, and logic configured to establish client connectivity to the resource.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a system for providing access to a resource.

FIG. 2 is a schematic representation of a computing device shown in FIG. 1.

FIG. 3 is an example graphical user interface for use with the system shown in FIG.

FIG. 4 is a flow diagram that illustrates operation of a control module identified in FIG. 2.

FIG. 5 is a flow diagram that illustrates operation of a connectivity module identified in FIG. 2.

FIG. 6 is an example correlation chart that can be used by the connectivity module identified in FIG. 2.

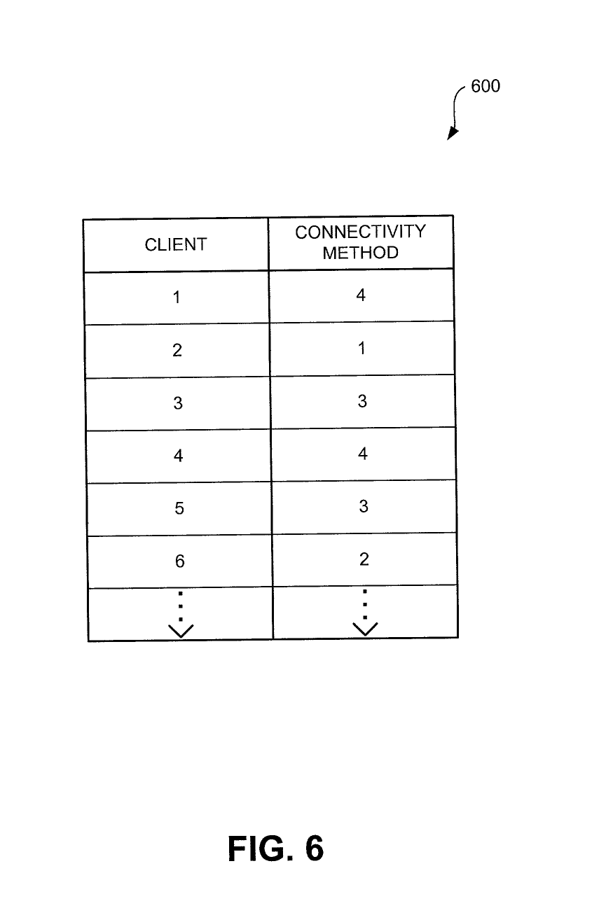

### DETAILED DESCRIPTION

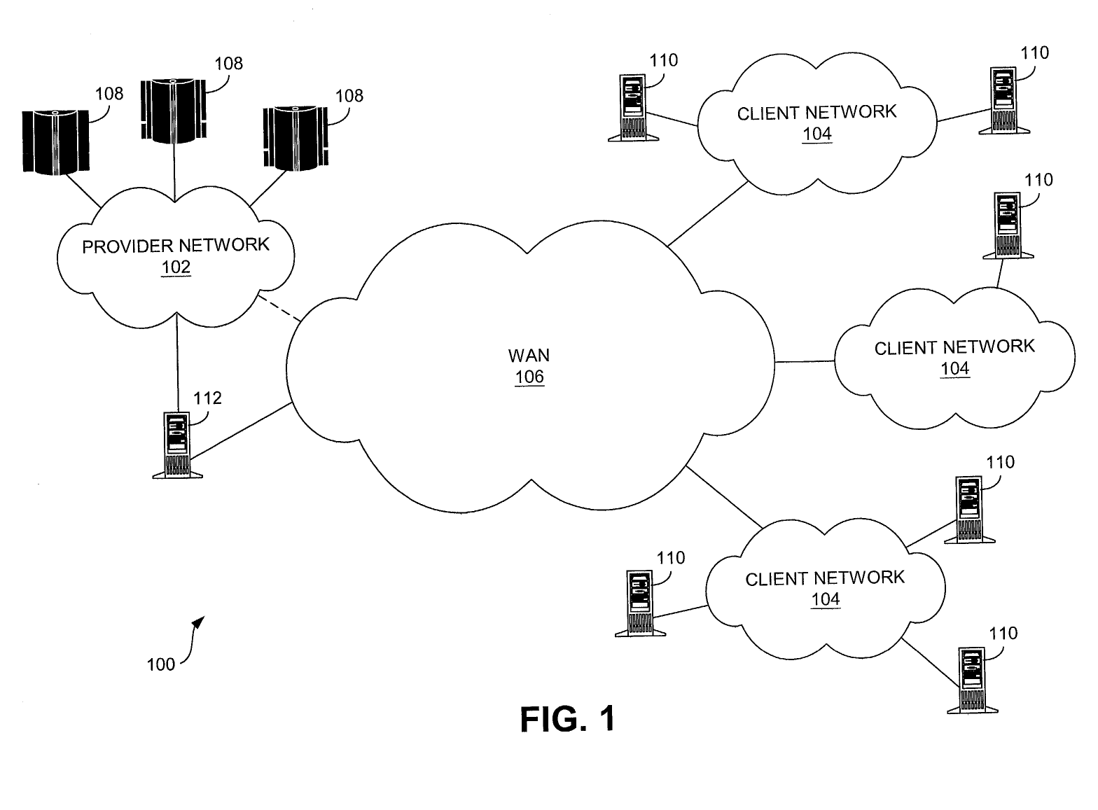

Referring now in more detail to the drawings, in which like numerals indicate corresponding parts throughout the several views, FIG. 1 illustrates a system 100 for providing access to a resource. As indicated in FIG. 1, the system 100 can comprise several different networks including a service provider network 102, one or more client networks 104, and a wide area network (WAN) 106 through which connectivity between the client networks and the service provider network can be established. Although a particular arrangement of networks is shown in FIG. 1, it is to be understood that this arrangement is merely exemplary in nature and that many other arrangements are feasible and could be used to facilitate connectivity. Moreover, although single networks are illustrated, persons having ordinary skill in the art will appreciate that one or more of these networks can comprise two or more sub-networks (i.e., subnets). As is discussed in more detail below, the configuration of the client networks 104 can vary such that different methods are required to establish connectivity between the individual client networks and the service provider network 102.

Also shown in FIG. 1 are one or more resources 108 that are connected to the service provider network 102 and that, under the control of the service provider, can be accessed by the various clients. By way of example, these resources 108 can comprise high speed computers. It will be appreciated, however, that the resources 108 can comprise substantially any resource that a client may wish to remotely access and use. Connected to the client networks 104 are computing devices (e.g., servers) 110 that are used by the clients to transmit data to and receive data from the service provider network 102 and, more particularly, one or more of the service provider resources 108. As indicated in FIG. 1, one or more such computing devices 110 can be connected to each client network 104. Shown connected to the service provider network 102 and the WAN 106 is a service provider computing device 112 that, by way of example, can also comprise a server. As is described in detail below, the computing device 112 can be operated by a service provider administrator (or other person) so as to grant or deny clients access to the provider network 102 and the resources 108 connected thereto.

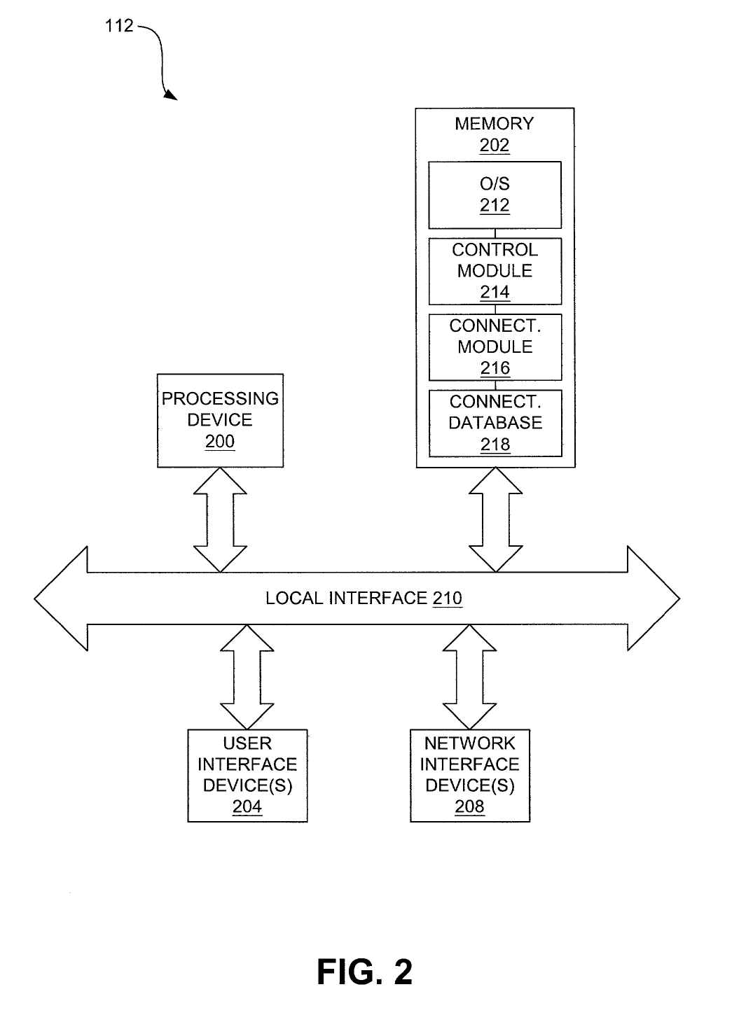

FIG. 2 is a schematic view illustrating an example architecture for the service provider computing device 112 shown in FIG. 1. As indicated in FIG. 2, the computing device 112 generally comprises a processing device 200, memory 202, at least one user interface device 204, and at least one network interface device 208, each of which is connected to a local interface 210 that, by way of example, comprises one or more internal and/or external buses. The processing device 200 comprises hardware for executing software that is stored in the memory 202 and can include, for example, a central processing unit (CPU) or an auxiliary processor among several processors associated with the computing device 112, a semiconductor based microprocessor (in the form of a microchip), or a macroprocessor. The memory 202 can include any one of combination of volatile memory elements (e.g., random access memory (RAM, such as DRAM, SRAM, etc.)) and nonvolatile memory elements (e.g., ROM, hard drive, tape, CDROM, etc.). Moreover, the memory 202 can incorporate electronic, magnetic, optical, and/or other types of storage media.

The one or more user interface devices 204 can include those tools normally used to communicate with a computing device such as a server including, for instance, a keyboard, mouse, and display. The one or more network interface devices 208 comprise the various hardware with which the computing device 112 transmits and receives data over the networks. By way of example, the network interface devices 208 can include a modulator/demodulator (e.g., modem), an RF or other transceiver, a telephonic interface, a bridge, a router, etc.

As indicated in FIG. 2, the memory 202 comprises various software programs. In particular, the memory 202 includes an operating system 214, a control module 214, and a connectivity module 216. The operating system 214 controls the execution of other software, such as the control module 214 and connectivity module 216, and provides scheduling, input-output control, file and data management, memory management, and communication control and related services. As described in more detail below, the control module 214 is adapted to present the user (e.g., service provider administrator) with a graphical user interface (GUI) with which the user can operate the connectivity module 216 which facilitates connectivity between the client networks 104 and the service provider resources 108. As described below, the GUI presented to the user is configured such that connectivity can be provided through the same on screen process, regardless of the client network configuration. Connectivity is attained by the connectivity module 216 with reference to data stored in the connectivity database 218 of the memory 202.

Various software has been described herein. It is to be understood that this software can be stored on any computer readable medium for use by or in connection with any computer related system or method. In the context of this document, a computer readable medium is an electronic, magnetic, optical, or other physical device or means that can contain or store a computer program for use by or in connection with a computer-related system or method. The software can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the software for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

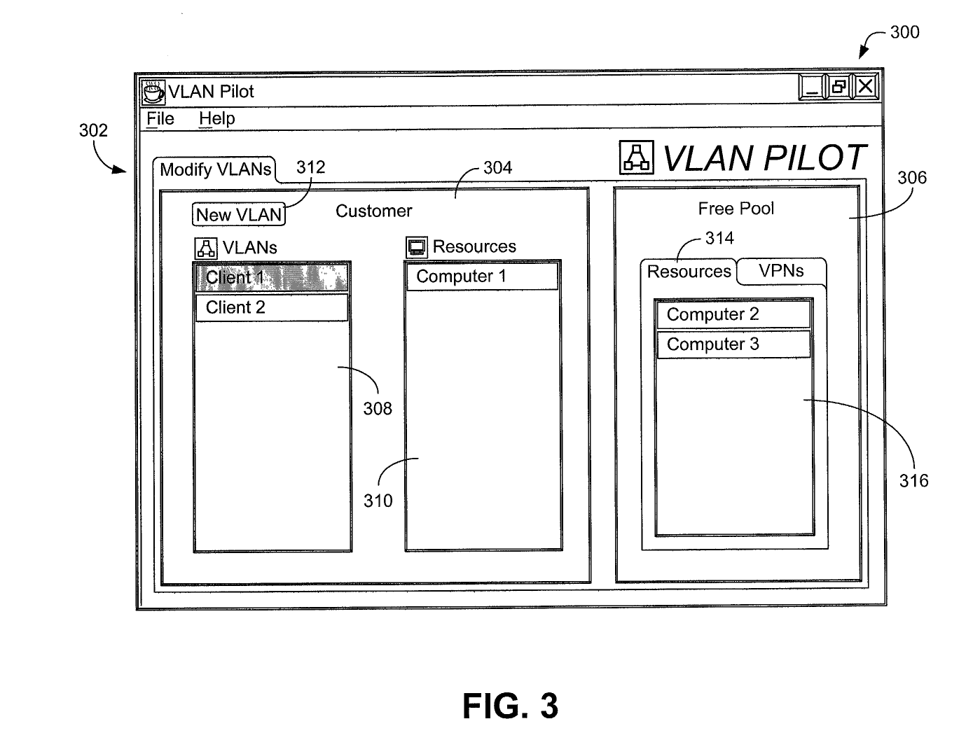

As identified above, it would be desirable for a user (e.g., service provider administrator) to have a tool with which connectivity can be established in a more simple manner irrespective of the configuration of the client network. More specifically, it would be desirable to have a tool with which connectivity can be established in an at least partially automated process such that highly skilled users are not needed. Such operation is provided by the control module 214 and connectivity module 216. The control module 214 generates an application that uses a control GUI that is operated by the user in the same manner regardless of the particular network configuration the client is using. An example GUI 300 is shown in FIG. 3. This GUI 300 (entitled “VLAN Pilot”) is used to enable connectivity for one or more clients. For instance, the GUI 300 can be used to construct virtual local area networks (VLANs) through with connectivity can be provided to one or more clients. Alternatively, the GUI 300 can provide similar connectivity without creating a VLAN by renumbering an existing but disconnected VLAN to a VLAN number for which connectivity was previously enabled.

As indicated in FIG. 3, the GUI 300 can have a look and feel common to Windows-type software programs to present a familiar format to the user. The GUI 300 can include a “Modify VLANs” folder 302 that is specifically configured for modifying the service provider formulated VLANs. Although other such folders can be provided, they are not shown or described herein as being beyond the scope of this disclosure. As depicted in FIG. 3, the Modify VLANs folder 302 can comprise a “Customer” window 304 and a “Free Pool” window 306. As described below, the Customer window 304 is used to identify VLANs that have been created for particular clients, and to identify to which resources those clients have access. In the example configuration shown in FIG. 3, the Customer window includes a “VLANs” subwindow 308 that identifies the VLANs that have been created, and a “Resources” subwindow 310 that identifies the resources associated with the VLANs. In addition, the Customer window 304 can include a “New VLAN” button 312 that, as is described below, is used to create new VLANs for clients. The “Free Pool” window 306 is used to identify the resources that are available for use by a client. By way of example, this window 306 can include a “Resources” subfolder 314 that includes a resources subwindow 316 that lists the available resources.

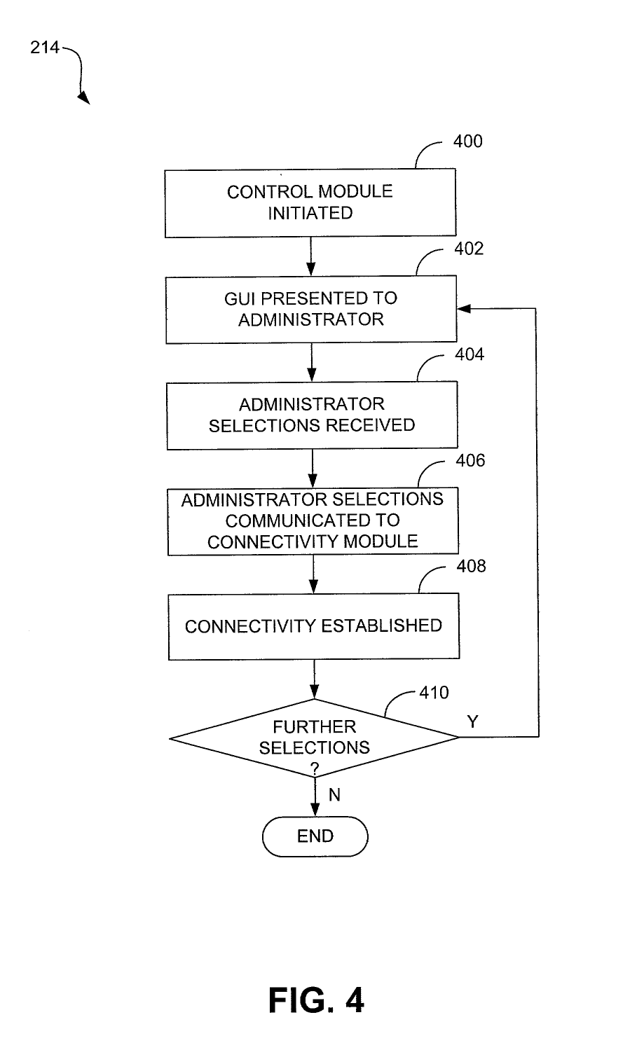

FIG. 4 illustrates an example mode of operation of the control module 214 shown in FIG. 2. More particularly, FIG. 4 illustrates the manner in which access to (i.e., connectivity with) one or more service provider resources 108 is controlled through manipulation of a GUI such as GUI 300. As indicated in block 400, the control module 214 is first initiated and, as indicated in block 402, the control module presents the administrator with a control GUI, such as GUI 300. Once the GUI is presented, the control module 214 is prepared to receive connectivity instructions from the administrator. If, for instance, a client contracts with the service provider for a predetermined duration of access to a resource (e.g., high speed computer), the administrator can be notified that client is to be provided with this access.

At this point, the administrator can enable connectivity for the client so the client will be able to access the service provider resource(s). With reference to the example GUI 300 shown in FIG. 3, the VLAN can be created by first selecting the New VLAN button 312. Selection of this button 312 can generate a pop-up box (not shown) in which the user can select a client, e.g., from a pull-down menu of the service provider's clients, for which a VLAN is to be created. Once the client is selected, the newly created VLAN can be displayed in the VLANs subwindow 308 under the name of the client. By way of example, FIG. 3 shows two client VLANs have been created, one for “Client 1” and another for “Client 2.” Once the client VLAN has been “created” in this manner, the administrator can select the resources to which the client will be given access. This can be accomplished by selecting resources from the resources subwindow 316 and associating them with the particular client. For instance, the administrator can “drag” each desired resource from the resources subwindow 316 and “drop” them on the particular client listed in the VLANs subwindow 308. Persons having ordinary skill will appreciate that other typical GUI manipulations can be used, if desired. As indicated in FIG. 3, “Client 1” (highlighted) has been provided access to “Computer 1” as indicated in the Resources subwindow 310.

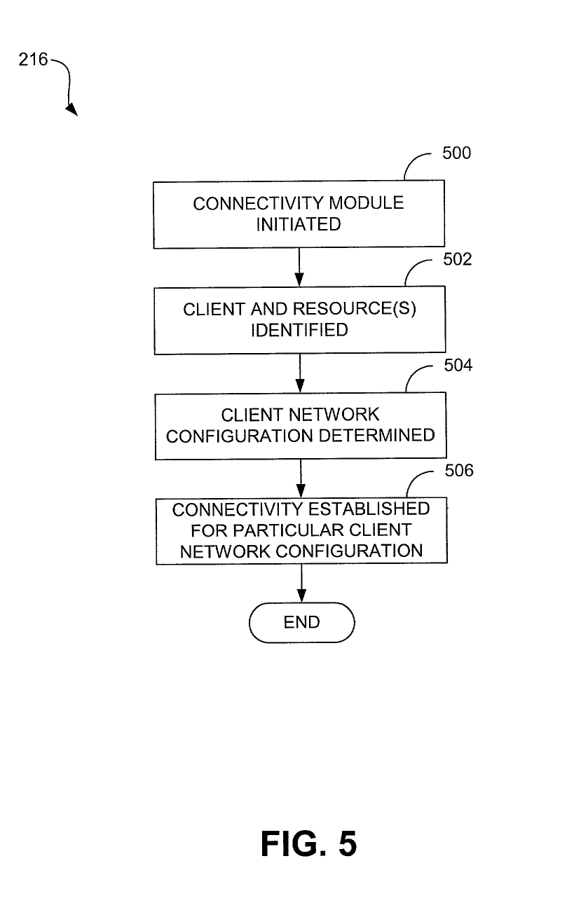

With reference back to FIG. 4, the administrator selections are received, as indicated in block 404, either continually as they are entered or at once after all selections have been made. In either case, the administrator selections are communicated by the control module 214 to the connectivity module 216 such that the VLAN can actually be created for the client and connectivity established, as indicated in block 408. Preferably, this connectivity is established automatically under the control of various software contained within the connectivity module 216. FIG. 5 illustrates an example mode of operation of the connectivity module 216 in establishing this connectivity. As indicated in block 500, the connectivity module 216 is first initiated. Normally, such initiation occurs in response to the communication from the control module 214 identified above. From this communication, the connectivity module 216 can identify who the client is and which resources are to be made available to the client, as indicated in block 502.

As mentioned above, it is important to know who the client is in facilitating connectivity in that each client may operate a differently configured network 104 and therefore may require a different connectivity method. In that, to maintain the simplicity of the GUI, the network configuration is not identified to the administrator, the connectivity module 216 must determine what network configuration the client uses, as indicated in block 504. With regard to FIG. 5, this determination can be made with reference to a correlation chart 600 stored within the connectivity database 218 which crosses the client name (or a code associated with the client) with the connectivity method used for the each client's network.

Once the network configuration has been determined, connectivity can be established for the client, as indicated in block 506. As is known in the art, a variety of connectivity methods are currently available and many others are being developed. For instance, in a simplified arrangement, connectivity can be established by the generation of a problem ticket that is issued through a workflow management system to a human being that physically plugs the client connector into the appropriate access device (e.g., switch) to provide service to the client. In another arrangement, where the client is statically connected to a VLAN switch port within the service provider network 102 and the VLAN switch is normally configured to isolate this client port, the VLAN switch can be reconfigured (e.g., through commands issued through a telnet connection or via simple network management protocol (SNMP) management traffic) so as to add the dedicated client port to the port-based VLAN to which the requested resources are already connected. In an inverted variation of this arrangement, in the VLAN switch can be reconfigured so as to add all pertinent resources to the client's VLAN.

In another example, one or more routing devices can be modified to enable routing between the client VLAN and the target resource(s). This can be accomplished, for instance, by creating static routing table entries that allow relevant protocols to route between the client VLAN and the various network addresses and protocol ports associated with the service provider resources. In yet a further example, where the static routing entries described above are permanently configured and service provider firewall devices are used, access control lists (ACLs) in the firewall configuration can be modified to provide access. In a last example, instead of having a permanently established client port, an equivalent connection can be dynamically created. This dynamic connection could either be a virtual private network (VPN) tunnel, an asynchronous transfer mode (ATM) virtual circuit, or some future technology for rapidly establishing a private connection. As will be appreciated by persons having ordinary skill in the art, myriad existing and yet to be created connectivity methods may apply. Although several methods are explicitly noted herein, it is to be understood that the actual method used is not important. More important, however, is that, irrespective of the connectivity method used, manipulation of the GUI is the same for the administrator, thereby simplifying the administrator's task and reducing the likelihood of mistakes.

Returning to decision element 410 of FIG. 4, it can then be determined if other selections are to be made by the administrator, e.g., to provide access to another client. If so, flow returns to block 402 and connectivity is provided in similar manner to that described above. If not, flow is terminated. Once connectivity has been provided, the administrator can be notified as to this fact with the GUI, and the client can use the resource 108 for the allotted amount of time. Once this time expires, withdrawal of connectivity can be automatic (i.e., connectivity is set to expire) or can be obtained by reversing the steps through which connectivity was provided. From the perspective of the administrator, this withdrawal of connectivity can be accomplished, for instance, by dragging resources away from the client (VLAN) or through other common methods of GUI manipulation (e.g., selection of an appropriate button, etc.).

While particular embodiments of the invention have been disclosed in detail in the foregoing description and drawings for purposes of example, it will be understood by those skilled in the art that variations and modifications thereof can be made without departing from the scope of the invention as set forth in the following claims. For instance, although the grant of access to the service provider resources is described as being controlled by a service provider administrator, it is to be appreciated that such control could be given to another operator, such as a client administrator, if desired. In such a situation, however, operation is similar to that described above.

What is claimed is:

1. A method for providing access to a resource, comprising the steps of:
providing a graphical user interface (GUI) to an operator with which client connectivity with the resource can be enabled, the GUI being configured such that the process used by the operator to facilitate connectivity using the GUI is the same regardless of which underlying connectivity method is used;
receiving commands of the operator with the GUI that convey the identity of the client and the resource to be accessed by the client;
determining the client network configuration; and
establishing client connectivity to the resource.

2. The method of claim 1, wherein the GUI comprises lists of clients and available resources.

3. The method of claim 2, wherein the step of receiving commands comprises first receiving selection of a client for which connectivity is to be provided.

4. The method of claim 3, wherein the step of receiving commands further comprises detecting association of a resource with a client VLAN.

5. The method of claim 4, wherein association of a resource with a client VLAN is communicated with the GUI by dragging the resource and dropping it on the client VLAN.

6. The method of claim 1, wherein the step of determining the client network configuration comprises accessing a connectivity database that stores the client network configurations.

7. A system for providing access to a resource, comprising:
means for providing a graphical user interface (GUI) to an operator with which client connectivity with the resource can be enabled, the GUI being configured such that the process used by the operator to facilitate connectivity using the GUI is the same regardless of which underlying connectivity system is used;
means for receiving commands of the operator with the GUI that convey the identity of the client and the resource to be accessed by the client;
means for determining the client network configuration; and
means for establishing client connectivity to the resource.

8. The system of claim 7, wherein the GUI comprises lists of clients and available resources.

9. The system of claim 8, wherein the means for receiving commands comprises means for receiving selection of a client for which connectivity is to be provided.

10. The system of claim 9, wherein the means for receiving commands further comprises means for detecting association of a resource with a client VLAN.

11. The system of claim 7, wherein the means for determining the client network configuration comprises means for accessing a connectivity database that stores the client network configurations.

12. A computer readable medium for providing access to a resource, comprising:
logic configured to provide a graphical user interface (GUI) to an operator with which client connectivity to the resource is enabled, the GUI being configured such that the process used by the operator to facilitate connectivity using the GUI is the same regardless of which underlying connectivity computer readable medium is used;
logic configured to receive commands of the operator with the GUI that convey the identity of the client and the resource to be accessed by the client;
logic configured to determine the client network configuration; and
logic configured to establish client connectivity to the resource.

13. The computer readable medium of claim 12, wherein the GUI comprises lists of clients and available resources.

14. The computer readable medium of claim 13, wherein the logic configured to receive commands comprises logic configured to receive selection of a client for which connectivity is to be provided.

15. The computer readable medium of claim 14, wherein the logic configured to receive commands further comprises logic configured to detect association of a resource with a client VLAN.

16. The computer readable medium of claim 12, wherein the logic configured to determine the client network configuration comprises logic configured to access a connectivity database that stores the client network configurations.
